(19) United States
(12) Patent Application Publication
(10) Pub. No.: US 2026/0057675 A1
(43) Pub. Date: Feb. 26, 2026

(54) Surveillance System of Multiple Video/Audio Source

(71) Applicant: AVTECH Security Corp., Taipei City (TW)

(72) Inventors: Chun-Ru Huang, Taipei City (TW); Chun-Ping Chen, Taipei City (TW); Ming-Sheng Cheng, Taipei City (TW)

(21) Appl. No.: 19/306,142

(22) Filed: Aug. 21, 2025

(30) Foreign Application Priority Data
Aug. 22, 2024 (TW) 113131537

(51) Int. Cl. G06V 20/52

(52) U.S. Cl. CPC G06V 20/52

(57) ABSTRACT

A surveillance system of multiple video/audio source is provided, which includes a first surveillance device, a second surveillance device, a network video interface conversion device, and a user device. The first surveillance device acquires first surveillance data, and the second surveillance device acquires second surveillance data. The network video interface conversion device is connected to the first surveillance device and the second surveillance device, and sets the universally unique identifiers (UUIDs) and ports of the surveillance devices via a conversion protocol compliant with the open network video interface forum (ONVIF). The user device is connected to the network video interface conversion device, and the first and second surveillance devices are defined as independent network surveillance devices.

### CROSS-REFERENCE TO RELATED APPLICATION

The present application claims priority to, and the benefit of, Taiwan Patent Application No. 113131537, filed on Aug. 22, 2024, in the Taiwan Intellectual Property Office, the disclosure of which is incorporated by reference herein in its entirety.

### BACKGROUND OF THE INVENTION

### 1. Field of the Invention

The present disclosure relates to a surveillance system of multiple video/audio source, and more particularly to a surveillance system for managing multiple video/audio sources using a conversion protocol compliant with the open network video interface forum (ONVIF).

### 2. Description of the Related Art

Conventional surveillance systems may include digital network cameras and traditional analog cameras, and perform monitoring by capturing video or audio-visual footage of specific areas. Users may be able to monitor the status and safety of a surveillance area by reviewing the video/audio content. For example, surveillance cameras installed in residential buildings may capture video and/or audio contents of areas such as the surroundings of the building, entrances/exits, and elevator spaces, allowing security personnel or residents to monitor the captured contents through network-connected devices or access control systems to ensure safety within the monitored area. In the event of an incident, the surveillance cameras may enable measures to be taken at early stages and further damages may be prevented.

To ensure that each video/audio feed is transmitted clearly and in real time to the user end, a comprehensive video/audio transmission and management architecture must be in place. However, different types of surveillance devices, particularly traditional analog cameras, typically require brand-specific converters to convert analog signals into digital formats suitable for network transmission. Due to differences in formats among different brands, compatibility between devices is low. In environments with multiple video/audio sources, setting up a surveillance system and the corresponding conversion devices is considerably challenging.

In view of this, existing network-based surveillance systems still face implementation difficulties when it comes to building system architecture and supporting multiple video/audio sources, resulting in limitations in video/audio transmission and remote monitoring operations. To address these shortcomings in the prior art, the inventors of the present disclosure have conceived and designed a surveillance system of multiple video/audio source to overcome these technical issues and enhance practical implementation in the industry.

### SUMMARY OF THE INVENTION

In view of the aforementioned problems in the conventional technologies, an objective of the present disclosure is to provide a surveillance system of multiple video/audio source, which addresses the difficulty of effective conversion and management in conventional surveillance systems when processing multiple video and audio sources.

According to one aspect of the present disclosure, a surveillance system of multiple video/audio source is provided, comprising a first surveillance device, a second surveillance device, a network video interface conversion device, and a user device. The first surveillance device is configured to face a first surveillance area to acquire first surveillance data, and the second surveillance device is configured to face a second surveillance area to acquire second surveillance data. The network video interface conversion device is respectively connected to the first surveillance device and the second surveillance device. The network video interface conversion device includes a conversion protocol of an open network video interface forum (ONVIF), and the network video interface conversion device is configured to set, through the conversion protocol, a first universally unique identifier (UUID) and a first port of the first surveillance device, and a second UUID and a second port of the second surveillance device. The user device is connected to the network video interface conversion device via a network interface. Through a network service dynamic discovery protocol, the first surveillance device and the second surveillance device are defined as independent network surveillance devices, the first imaging device transmits the first surveillance data to the user device through the first port, and the second imaging device transmits the second surveillance data to the user device through the second port.

Preferably, the first surveillance device may be a first camera lens of a multi-lens network camera, and the second surveillance device may be a second camera lens of the multi-lens network camera.

Preferably, the first surveillance device may be a network camera, and the second surveillance device may be an analog camera.

Preferably, the first surveillance device may be a first analog camera, and the second surveillance device may be a second analog camera.

Preferably, the first surveillance device may be a first channel of an analog camera, and the second surveillance device may be a second channel of the analog camera, and the first channel may be configured for transmitting video data and the second channel may be configured for transmitting audio data.

Preferably, the network video interface conversion device includes a video management system, a digital video recorder (DVR), a network video recorder (NVR), or a network-attached storage (NAS) device.

Preferably, the user device includes a smartphone, a tablet computer, a laptop computer, a desktop computer, or a server computer.

As described above, the surveillance system of multiple video/audio source according to the present disclosure may have one or more of the following advantages:
(1) The surveillance system of multiple video/audio source may be applied to multi-lens network camera devices or multi-channel analog camera devices, thereby resolving compatibility issues among different types of imaging devices and facilitating easier setup, management, and expansion of surveillance systems.
(2) The surveillance system of multiple video/audio source may allow configuration of universally unique identifiers (UUIDs) and ports for different surveillance devices, enabling the user device to recognize multiple video/audio sources as independent devices during discovery. Each device transmits surveillance data through its respective port, reducing network bandwidth consumption and improving transmission efficiency.
(3) The surveillance system of multiple video/audio source may be adaptable to combinations of multiple network cameras or analog cameras, making it suitable for surveillance setups in different environments or monitoring areas, thereby enhancing system deployment efficiency and reducing setup costs.

### BRIEF DESCRIPTION OF THE DRAWINGS

In order to make the technical features, contents and advantages of the present invention and the effects that may be achieved more obvious, the present invention is described in detail as follows with reference to the accompanying drawings and in the form of an embodiment:

FIG. 1 is a schematic diagram of the surveillance system of multiple video/audio source according to an embodiment of the present disclosure;

FIG. 2 is a schematic diagram of a surveillance system according to a first embodiment of the present disclosure;

FIG. 3 is a schematic diagram of a surveillance system according to a second embodiment of the present disclosure;

FIG. 4 is a schematic diagram of a surveillance system according to a third embodiment of the present disclosure; and

FIG. 5 is a schematic diagram of a surveillance system according to a fourth embodiment of the present disclosure.

### DETAILED DESCRIPTION OF THE PREFERRED EMBODIMENTS

In order to facilitate understanding of the technical features, contents and advantages of the present invention and the effects that may be achieved, the present invention is hereby described in detail as follows with the accompanying drawings and in the form of embodiments. The drawings used therein are only for illustration and auxiliary description, and may not be the true proportions and precise configurations after the implementation of the present invention. Therefore, the proportions and configurations of the attached drawings should not be interpreted to limit the scope of rights of the present invention in actual implementation.

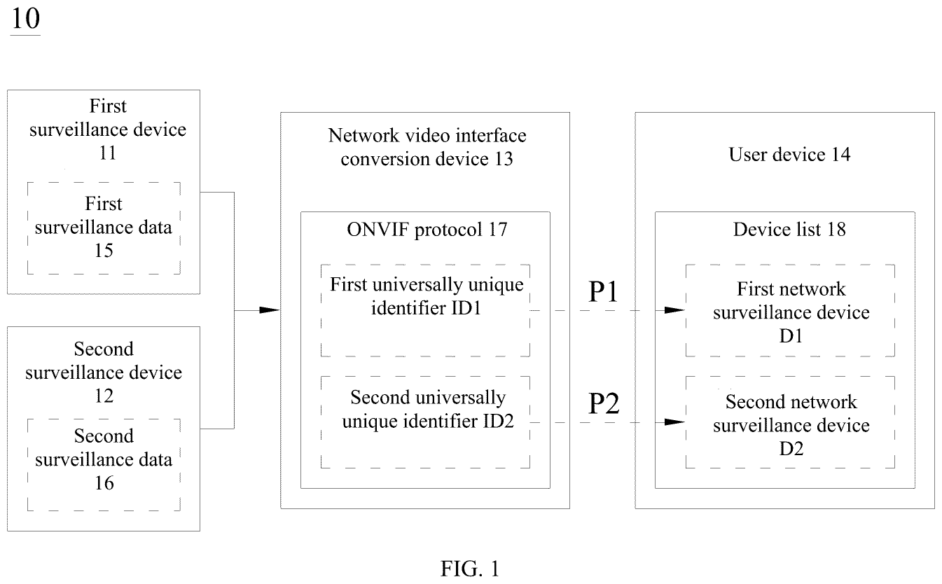

Referring to FIG. 1, FIG. 1 is a schematic diagram of the surveillance system of multiple video/audio source according to an embodiment of the present disclosure. As shown in FIG. 1, the surveillance system of multiple video/audio source 10 includes a first surveillance device 11, a second surveillance device 12, a network video interface conversion device 13, and a user device 14. The first surveillance device 11 may be oriented toward a first surveillance area to acquire first surveillance data 15, and the second surveillance device 12 may be oriented toward a second surveillance area to acquire second surveillance data 16. The first surveillance device 11 and the second surveillance device 12 may monitor the same or different surveillance areas and acquire video/audio recordings of the surveillance areas, serving as multiple data sources for the surveillance system. In the present embodiment, the first surveillance device 11 and the second surveillance device 12 are used to illustrate multiple surveillance data sources. However, the number of surveillance devices disclosed herein is not limited thereto. In other embodiments, the multiple video/audio sources may originate from three or more surveillance devices, for example, eight or sixteen surveillance devices.

The first surveillance data 15 acquired by the first surveillance device 11 and the second surveillance data 16 acquired by the second surveillance device 12 may be in the same or different video/audio formats. For example, the first surveillance data 15 may be video and audio data captured by an analog camera, while the second surveillance data 16 may be audio-visual data captured by a network camera. The types of surveillance devices and their corresponding surveillance data formats will be further described in the following embodiments.

The network video interface conversion device 13 is connected to the first surveillance device 11 and the second surveillance device 12. The network video interface conversion device may include a Video Management System (VMS), a Digital Video Recorder (DVR), a Network Video Recorder (NVR), or a Network Attached Storage (NAS) device. As the types, manufacturers, and models of surveillance devices may vary, different conversion devices may be selected accordingly. For instance, a network camera (IP camera) may be connected to a network video recorder, an analog camera may be connected to a digital video recorder, or a surveillance device may be connected to a video management system.

As mentioned earlier, due to the wide variety of surveillance devices, differences in transmission and format settings often result in incompatibility between devices. To address this, the network video interface conversion device 13 may adopt the standards proposed by the Open Network Video Interface Forum (ONVIF), namely the ONVIF protocol 17. ONVIF is an open industry forum focused on developing global standards for IP-based security products, such as connections between network cameras and NVRs, network cameras and video management systems, access control systems, and more. The detailed mechanisms of ONVIF, for example, the ONVIF Core Specification, may be found on http://www.onvif.org/, and the disclosure of which is incorporated by reference herein in its entirety. Under normal circumstances, a single network camera represents one surveillance data source and is managed via the ONVIF protocol 17. However, in real-world surveillance environments, multiple surveillance devices or multiple camera lenses within a single device are often deployed, requiring the network video interface conversion device 13 to receive multiple video/audio sources. According to conventional protocol implementations, such multi-source conversion results in a multiplicative increase in communication data volume, leading to network bandwidth issues. In addition, traditional analog surveillance systems, due to their relatively low setup cost, still hold a significant market share. These types of surveillance devices typically support multiple channels, such as separate sources for transmitting video and audio. When these types of surveillance devices are converted into network-based surveillance devices via the ONVIF protocol 17, the multi-channel characteristics similarly lead to a significant increase in network data traffic, causing bandwidth problems and presenting challenges in direct compatibility and system integration.

Accordingly, under the same ONVIF protocol 17, according to the present embodiment, the network video interface conversion device 13 may be configured to assign the first surveillance device 11 with a first universally unique identifier ID1 and a first port P1, and assign the second surveillance device 12 with a second universally unique identifier ID2 and a second port P2 through the conversion protocol. When a user operates the user device 14, such as a smartphone, tablet, laptop, desktop, or server computer, it may connect to the network video interface conversion device 13 via a network interface. Through the web services dynamic discovery (WS-Discovery) scheme provided by the ONVIF protocol 17, the first surveillance device 11 and the second surveillance device 12 may be rendered as independent network surveillance devices. WS-Discovery may allow ONVIF-compliant devices, like network cameras and video recorders, to be automatically discovered and accessed by client applications. WS-Discovery may use multicast messages to broadcast device information, enabling efficient and automated setup and management of IP-based security systems. For example, in a discovered device list 18, the first surveillance device 11 and the second surveillance device 12 may be displayed as a first network surveillance device D1 and a second network surveillance device D2, respectively. When the user views the first network surveillance device D1, the first surveillance device 11 transmits the first surveillance data 15 to the user device 14 via the first port P1. When the user views the second network surveillance device D2, the second surveillance device 12 transmits the second surveillance data 16 to the user device 14 via the second port P2. When the user device 14 is connected to the network video interface conversion device 13, although the network video interface conversion device 13 supports multiple video/audio sources, by configuring each source as an independent surveillance device, it only responds to the requested video/audio source, that is, based on the corresponding universally unique identifier and port when a viewing request is made, which reduces data transmission volume and enhances transmission efficiency.

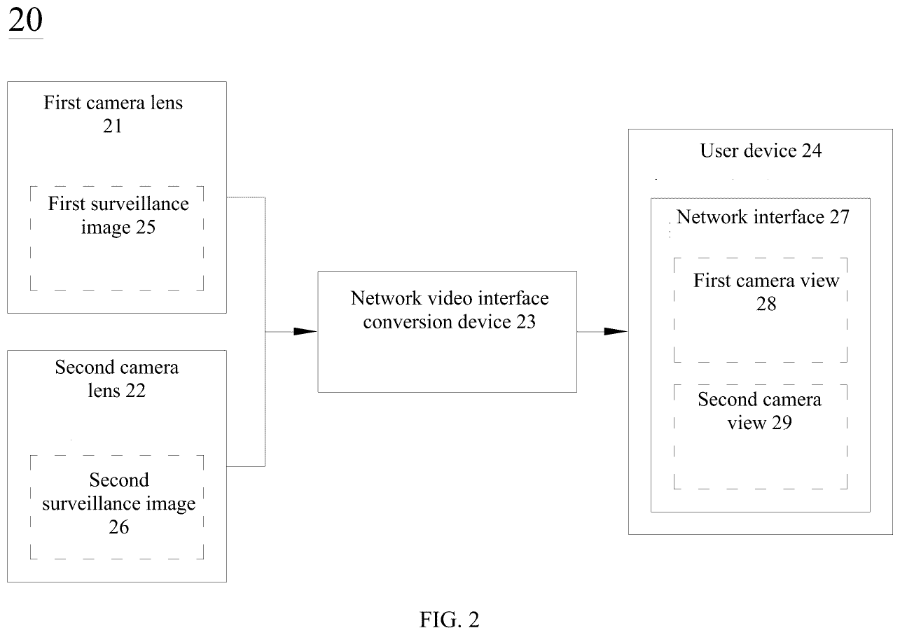

Referring to FIG. 2, FIG. 2 is a schematic diagram of a surveillance system according to a first embodiment of the present disclosure. As shown in FIG. 2, the surveillance system of multiple video/audio source 20 includes a first camera lens 21, a second camera lens 22, a network video interface conversion device 23, and a user device 24. The first camera lens 21 may be a camera lens of a network camera oriented toward a first surveillance area and captures a first surveillance video 25. The second camera lens 22 may be a camera lens of a network camera oriented toward a second surveillance area and captures a second surveillance video 26. The first camera lens 21 and the second camera lens 22 may be different lenses of a multi-lens network camera, or they may be lenses of separate network cameras. In the present embodiment, the multiple network camera devices are described by using the first camera lens 21 and the second camera lens 22 as examples; however, the disclosure is not limited thereto. In other embodiments, the surveillance system of multiple video/audio source 20 may include three or more network camera devices, with their respective camera lenses oriented toward designated areas to capture different surveillance videos.

Referring to the foregoing embodiment, the network video interface conversion device 23 is respectively connected to the first camera lens 21 and the second camera lens 22. Under the conversion protocol of ONVIF, the universally unique identifiers and ports of the first camera lens 21 and the second camera lens 22 are configured, such that each camera lens is treated as an independent surveillance device. Specifically, for example, the first camera lens 21 and the second camera lens 22 may be two different camera lenses of a single network camera device. Conventionally, with the WS-Discovery function provided by ONVIF, a single surveillance device would be listed on the device discovery list, and when communication is established between the user device and such single surveillance device, camera views from the two camera lenses thereof would appear on the user device. That is, the data of the surveillance videos of the two camera lenses would be simultaneously transmitted to the user device, which would occupy significant communication bandwidth. Differently, according to the embodiment of the present application, the first camera lens 21 and the second camera lens 22 are rendered as independent surveillance devices by the network video interface conversion device 23. When the user device 24 connects to the network video interface conversion device 23 via the network interface 27, the first camera lens 21 and the second camera lens 22 may be respectively displayed on the device discovery list as separate surveillance devices. Upon selecting the surveillance device with the first camera lens 21, the first surveillance video 25 is transmitted and displayed as a first camera view 28 on the screen; alternatively, upon selecting the surveillance device with the second camera lens 22, the second surveillance video 26 is transmitted and displayed as a second camera view 29 on the screen. The user may perform monitoring system control on the user device 24 through operations such as screen adjustment, selection, and switching.

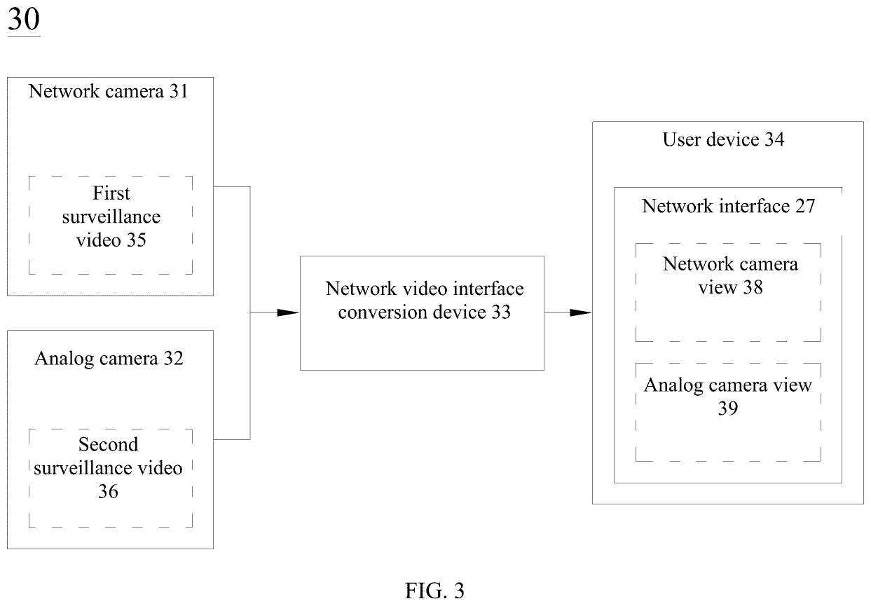

Referring to FIG. 3, FIG. 3 is a schematic diagram of a surveillance system according to a second embodiment of the present disclosure. As shown in FIG. 3, the surveillance system of multiple video/audio source 30 includes a network camera 31, an analog camera 32, a network video interface conversion device 33, and a user device 34. The network camera 31 may capture a first surveillance video 35 by recording the video of a first surveillance area, while the analog camera 32 may capture a second surveillance video 36 by recording a video of a second surveillance area. In this embodiment, the network camera 31 and the analog camera 32 are used to illustrate a combination of different types of surveillance devices. For example, a new network camera 31 may be added to an environment already equipped with a traditional analog camera 32 to monitor additional areas, or a lower-cost analog camera 32 may be installed in less critical areas under an existing network camera 31 setup. The present disclosure is not limited by the number of surveillance devices. In other embodiments, the surveillance system of multiple video/audio source 30 may include combinations of three or more network cameras 31 and analog cameras 32.

Referring to the foregoing embodiment, the network video interface conversion device 33 is respectively connected to the network camera 31 and the analog camera 32. Under the conversion protocol of ONVIF, the universally unique identifiers and ports of the network camera 31 and the analog camera 32 are configured, such that each is treated as an independent surveillance device. Specifically, for example, the network camera 31 may have multiple camera lenses, and the analog camera 32 may have multiple channels receiving video signals from multiple camera lenses. Conventionally, with the WS-Discovery function provided by ONVIF, two surveillance devices corresponding to the network camera 31 and the analog camera 32 would be listed on the device discovery list, and when the communication is established between the user device and the surveillance device corresponding to the network camera 31 or the analog camera 32, camera views from the multiple camera lenses or channels thereof would appear on the user device. That is, the data of the surveillance videos of the multiple camera lenses or multiple channels would be simultaneously transmitted to the user device, which would occupy significant communication bandwidth. Differently, according to the embodiment of the present application, the multiple camera lens of the network camera 31 and the multiple channels of the analog camera 32 are rendered as independent surveillance devices by the network video interface conversion device 33. When the user device 34 connects to the network video interface conversion device 33 via the network interface 37, the camera lenses of the network camera 31 and the channels of the analog camera 32 are respectively displayed on the discovered device list. Upon selecting a surveillance device corresponding to a camera lens of the network camera 31, the first surveillance video 35 of the camera lens is transmitted and displayed as the network camera view 38 on the screen; alternatively, upon selecting a surveillance device corresponding to a channel of the analog camera 32, the second surveillance video 36 of the channel is transmitted and displayed as the analog camera view 39. The user may perform monitoring system control on the user device 34 through operations such as screen adjustment, selection, and switching.

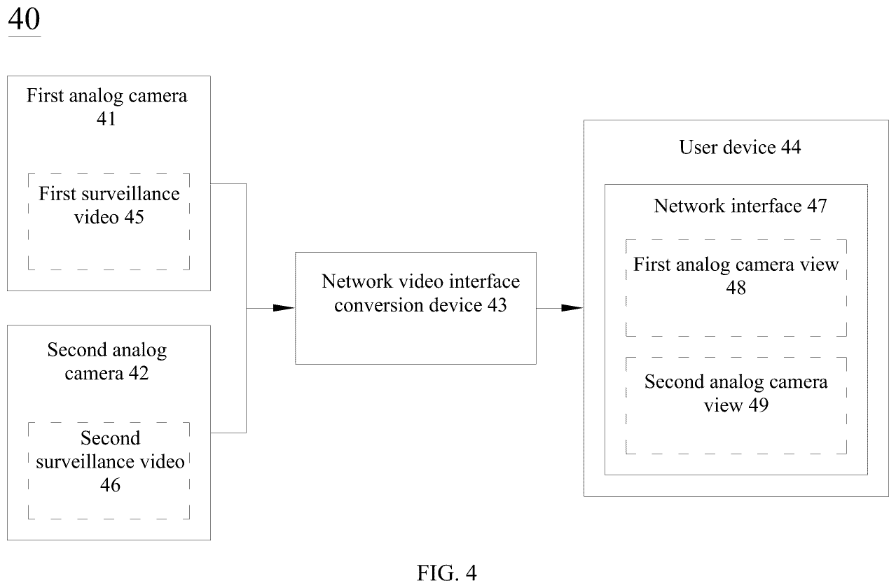

Referring to FIG. 4, FIG. 4 is a schematic diagram of a surveillance system according to a third embodiment of the present disclosure. As shown in FIG. 4, the surveillance system of multiple video/audio source 40 includes a first analog camera 41, a second analog camera 42, a network video interface conversion device 43, and a user device 44. The first analog camera 41 captures a first surveillance video 45 by recording a first surveillance area, and the second analog camera 42 captures a second surveillance video 46 by recording a second surveillance area. In this embodiment, the first analog camera 41 and the second analog camera 42 are used to describe multiple video sources from analog surveillance devices. However, the present disclosure is not limited thereto. In other embodiments, the surveillance system of multiple video/audio source 40 may include three or more analog surveillance devices, each oriented toward a designated area to capture different surveillance videos.

Referring to the foregoing embodiment, the network video interface conversion device 43 is respectively connected to the first analog camera 41 and the second analog camera 42. Under the conversion protocol of ONVIF, the universally unique identifiers and ports of the first analog camera 41 and the second analog camera 42 are configured, such that each is treated as an independent surveillance device. In one embodiment, for example, the first analog camera 41 may have a first set of channels each transmits an audio signal and/or a video signal, and the second analog camera 42 may have a second set of channels each transmits an audio signal and/or a video signal. Conventionally, with the WS-Discovery function provided by ONVIF, two surveillance devices corresponding to the first analog camera 41 and the second analog camera 42 would be listed on the device discovery list, and when the communication is established between the user device and the surveillance device corresponding to the first analog camera 41 or the second analog camera 42, camera views and/or audios from the first set of channels or the second set of channels would be played or streamed on the user device. That is, the data of the surveillance videos of each set of channels would be simultaneously transmitted to the user device, which would occupy significant communication bandwidth. Differently, according to the embodiment of the present application, the first set of channels of the first analog camera and the second set of channels of the second analog camera 42 are rendered as independent surveillance devices by the network video interface conversion device 43. When the user device 44 connects to the network video interface conversion device 43 via the network interface 47, the first set of channels of the first analog camera 41 and the second set of channels of the second analog camera 42 are respectively displayed on the discovered device list as separate surveillance devices. Upon selecting a surveillance device corresponding one channel among the first set of channels of the first analog camera 41, the first surveillance video 45 of such channel is transmitted and displayed as the first analog camera view 48 on the screen; alternatively, upon selecting a surveillance device corresponding one channel among the second set of channels of the second analog camera 42, the second surveillance video 46 of such channel is transmitted and displayed as the second analog camera view 49 on the screen. The user may operate the user device 44 to control the surveillance system through operations such as screen adjustment, selection, and switching.

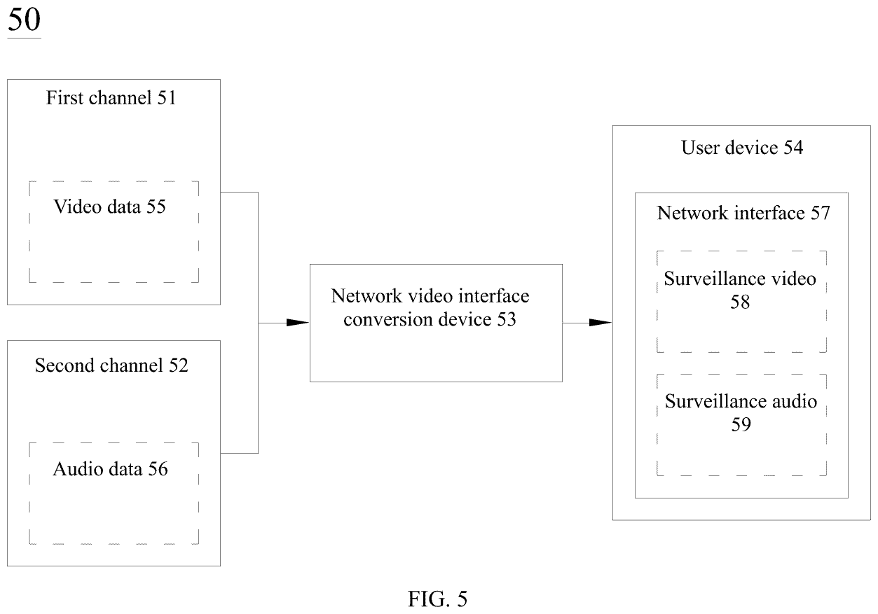

Referring to FIG. 5, FIG. 5 is a schematic diagram of a surveillance system according to a fourth embodiment of the present disclosure. As shown in FIG. 5, the surveillance system of multiple video/audio source 50 includes a first channel 51, a second channel 52, a network video interface conversion device 53, and a user device 54. The first channel 51 and the second channel 52 respectively transmit different surveillance data from an analog surveillance device, wherein the first channel 51 transmits video data 55, and the second channel 52 transmits audio data 56. In this embodiment, the first channel 51 and the second channel 52 are used to illustrate different channels of surveillance data. However, the present disclosure is not limited thereto. In other embodiments, the surveillance system of multiple video/audio source 50 may include multiple analog surveillance devices, or multiple channels formed by such devices, each acquiring corresponding surveillance data through different channels.

Referring to the foregoing embodiment, the network video interface conversion device 53 is respectively connected to the first channel 51 and the second channel 52. Under the conversion protocol of ONVIF, the universally unique identifiers and ports of the first channel 51 and the second channel 52 are configured, such that each is treated as an independent surveillance device. In one embodiment, for example, the first channel 51 and the second channel 52 may be two different channels of a single analog camera device. Conventionally, with the WS-Discovery function provided by ONVIF, a single surveillance device would be listed on the device discovery list, and when communication is established between the user device and such single surveillance device, camera views or audios from the two channels thereof would be played or streamed on the user device. That is, the data of the surveillance videos and/or audios of the two channels would be simultaneously transmitted to the user device, which may occupy significant communication bandwidth. Differently, according to the embodiment of the present application, the first channel 51 and the second channel 52 are rendered as independent surveillance devices by the network video interface conversion device 53. When the user device 54 connects to the network video interface conversion device 53 via the network interface 57, the first channel 51 and the second channel 52 are respectively displayed on the discovered device list as separate surveillance devices. Upon selecting the surveillance corresponding to the first channel 51, the video data 55 is transmitted and displayed as a surveillance video 58 on the screen; alternatively, upon selecting the surveillance corresponding to the second channel 52, the audio data 56 is transmitted and played as surveillance audio 59 on the user device. The user device 54 may also be combined with the surveillance video 58 and the surveillance audio 59 to present complete surveillance video and audio content. The user may operate the user device 54 to control the surveillance system through functions such as screen adjustment, selection, and switching.

The above description is for illustrative purposes only and is not intended to be limiting. Any equivalent modifications or alterations made without departing from the spirit and scope of the present disclosure shall be encompassed within the scope of the appended claims.

What is claimed is:

1. A surveillance system of multiple video/audio source, comprising:
a first surveillance device configured to face a first surveillance area to acquire first surveillance data;
a second surveillance device configured to face a second surveillance area to acquire second surveillance data;
a network video interface conversion device respectively connected to the first surveillance device and the second surveillance device, wherein the network video interface conversion device comprises a conversion protocol of an open network video interface forum (ONVIF), and the network video interface conversion device is configured to set, through the conversion protocol, a first universally unique identifier (UUID) and a first port of the first surveillance device, and a second UUID and a second port of the second surveillance device; and
a user device connected to the network video interface conversion device via a network interface, wherein, through a network service dynamic discovery protocol, the first surveillance device and the second surveillance device are defined as independent network surveillance devices, the first imaging device transmits the first surveillance data to the user device through the first port, and the second imaging device transmits the second surveillance data to the user device through the second port.

2. The surveillance system of multiple video/audio source according to claim 1, wherein the first surveillance device is a first camera lens of a multi-lens network camera, and the second surveillance device is a second camera lens of the multi-lens network camera.

3. The surveillance system of multiple video/audio source according to claim 1, wherein the first surveillance device is a network camera, and the second surveillance device is an analog camera.

4. The surveillance system of multiple video/audio source according to claim 1, wherein the first surveillance device is a first analog camera, and the second surveillance device is a second analog camera.

5. The surveillance system of multiple video/audio source according to claim 1, wherein the first surveillance device is a first channel of an analog camera, and the second surveillance device is a second channel of the analog camera, and the first channel is configured for transmitting video data and the second channel is configured for transmitting audio data.

6. The surveillance system of multiple video/audio source according to claim 1, wherein the network video interface conversion device includes a video management system, a digital video recorder (DVR), a network video recorder (NVR), or a network-attached storage (NAS) device.

7. The surveillance system of multiple video/audio source according to claim 1, wherein the user device includes a smartphone, a tablet computer, a laptop computer, a desktop computer, or a server computer.
